(19) United States
(12) Patent Application Publication
(10) Pub. No.: US 2012/0167344 A1
(43) Pub. Date: Jul. 5, 2012

(54) SHOCK-ABSORBER DEVICE

(75) Inventor: Guy Valembois, Lauzerville (FR)

(73) Assignee: CONSEIL ET TECHNIQUE, Lauzerville (FR)

(21) Appl. No.: 13/394,758

(22) PCT Filed: Sep. 7, 2010
(86) PCT No.: PCT/FR2010/051863

§ 371 Date: Mar. 7, 2012

(30) Foreign Application Priority Data
Sep. 10, 2009 (FR) 09 56180
Oct. 20, 2009 (FR) 09 57338

(51) Int. Cl. F16C 11/04; F16C 11/10; F16F 15/30

(52) U.S. Cl. 16/321; 16/354; 16/319

(57) ABSTRACT

The invention relates to a shock-absorber device intended to connect two parts, one part moves relative to the other part, owing solely to an initial temporary thrust provided by a driving device, thereby shifting from an initial position to an end position. The device includes a mechanical system connecting the parts in relative movement, which also includes a kinetic energy accumulator designed to be supplied by the above-mentioned initial thrust, and to return at least the exact amount of energy required to allow the mobile one part to reach the end position.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention is related to the field of the control of the movement, in particular of the control of the impacts during the implementation of a mechanical device, and relates to a shock-absorber device.

The shock-absorber device according to the invention finds applications in many fields such as, non-restrictively, the unfolding of solar-energy generating satellite appendices, antenna, mast, the locking of weapon parts, and the travel end dampening for an opening and closing device for an airplane door.

These fields require the dynamics of a movement to be controlled; at the same time, they make use of shock-absorbers using fluids complicated or expensive.

The present invention will find multiple applications for uses in cold or hot temperature ranges, which are inadequate for the use of fluids, and also when the storage time of such shock-absorbers is limited in time, namely the seals the storage time of which is relatively short.

2. Description of Related Art Including Information Disclosed Under 37 CFR 1.97 and 37 CFR 1.98.

In the particular field of the satellites, the solar-energy generators are rectangular panels stored in a position folded against the side faces of the satellite for launching and which are aimed at being unfolded when the satellite has reached its orbit. The panels are hinged to each other by motorized pivot links by springs. The amplitude of the movements is limited by mechanical stops, which permit to define the unfolded geometry. During this unfolding, the potential energy accumulated in the springs is converted into kinetic energy in the panels. The end of the movement thus occurs with a speed of impact against stops, which induces rebounds on the latter, whereby important mechanical impacts can produce breaks, disturbances in the very orientation of the satellite.

In order to limit the effects of the impact, it could be contemplated to reduce the force of the springs, but this is not compatible with the safety necessary for the unfolding of the panels, which requires a large operating margin.

Another solution consists in motorizing all the movements, with the drawback of an important increase of the weight of the whole, which is prohibitory in the field of space navigation.

### SUMMARY OF THE INVENTION

The aim of the present invention is to cope with all these drawbacks by providing a shock-absorber device permitting to considerably reduce the impact problems, while being capable of ensuring in addition a locking function.

The shock-absorber device according to the invention is aimed at connecting two parts, one of which is capable, under the sole effect of a temporary initial thrust, provided by a motor means, of moving with respect to the other one, in order to pass from an initial position into an end position, and it is characterized essentially in that it includes a mechanical system connecting said parts in a relative movement, and which incorporates a kinetic-energy accumulator designed capable of being supplied by said initial thrust, and of restituting at least the energy exactly necessary for permitting said movable part to reach said end position.

According to an additional feature of the shock-absorber device according to the invention, the relative movement consists of a swiveling motion of one part with respect to the other one, and the mechanical system comprises, on the one hand, a toothed wheel coaxial to the axis of said swiveling, and firmly integral with the movable part and designed capable of being driven in rotation during the initial thrust and, on the other hand, an inertia flywheel, which constitutes the kinetic accumulator, and which is directly or indirectly connected in rotation to said toothed wheel.

According to another additional feature of the shock-absorber device according to the invention, the mechanical system includes, intercalated between the toothed wheel and the inertia flywheel, a single- or multi-stage step-up gear.

According to another additional feature of the shock-absorber device according to the invention, the mechanical system includes a free wheel.

According to another additional feature of the shock-absorber device according to the invention, the mechanical system includes a catch designed capable of cooperating with a toothed wheel, in order to ensure a locking function.

According to another additional feature of the shock-absorber device according to the invention, the mechanical system includes at least at the level of a connection between a shaft and a toothed wheel, an element having elasticity features likely to ensure, in cooperation with the catch, a locking with pre-stress.

According to another additional feature of the shock-absorber device according to the invention, the mechanical system includes a torque-limiting means arranged at the level of the inertia flywheel.

According to another additional feature of the shock-absorber device according to the invention, the inertia flywheel has a varying diameter, it includes to this end a hub and at least one radially movable inertia weight, which are connected through connecting means having the possibility of extending and associated with centripetal springy restoring means.

According to another additional feature of the shock-absorber device according to the invention, the inertia flywheel with a varying diameter is arranged concentrically within a tubular element integral with the part, which carries said inertia flywheel, and the inner diameter of which corresponds to the one reached by said inertia flywheel at a certain speed of rotation, so that beyond this speed the inertia weight, or the inertia weights, of said inertia flywheel rub against the inner wall of said tubular element, in order to carry out the braking.

According to another additional feature of the shock-absorber device according to the invention, it includes several inertia flywheels capable of being used in opposite directions of rotation, by being mounted on free wheels so as to be active only in one direction of rotation, and so as to obtain different responses depending on the transmitted direction of rotation.

The advantages and features of the shock-absorber device according to the invention will become clear from the following description, which relates to the attached drawing, which represents a non-restrictive embodiment of same.

### BRIEF DESCRIPTION OF THE DRAWINGS

FIG. 1 represents a schematic perspective view of a mechanical unit provided with a shock-absorber device according to the invention.

FIGS. 2a, 2b, 2c and 2d represent schematic elevation views of the same mechanical unit comprising the same shock-absorber device in different phases.

FIGS. 3a and 3b represent schematic elevation views of the same mechanical unit comprising the same shock-absorber device in two different phases.

FIG. 4 represents a schematic perspective view of part of the same mechanical unit comprising a variant of the shock-absorber device according to the invention.

FIG. 5 represents a schematic perspective view of a variant embodiment of the shock-absorber device according to the invention.

FIG. 6 represents a schematic perspective view of a part of the variant of FIG. 5.

FIG. 7 represents a schematic perspective view of another embodiment of the part shown in FIG. 6.

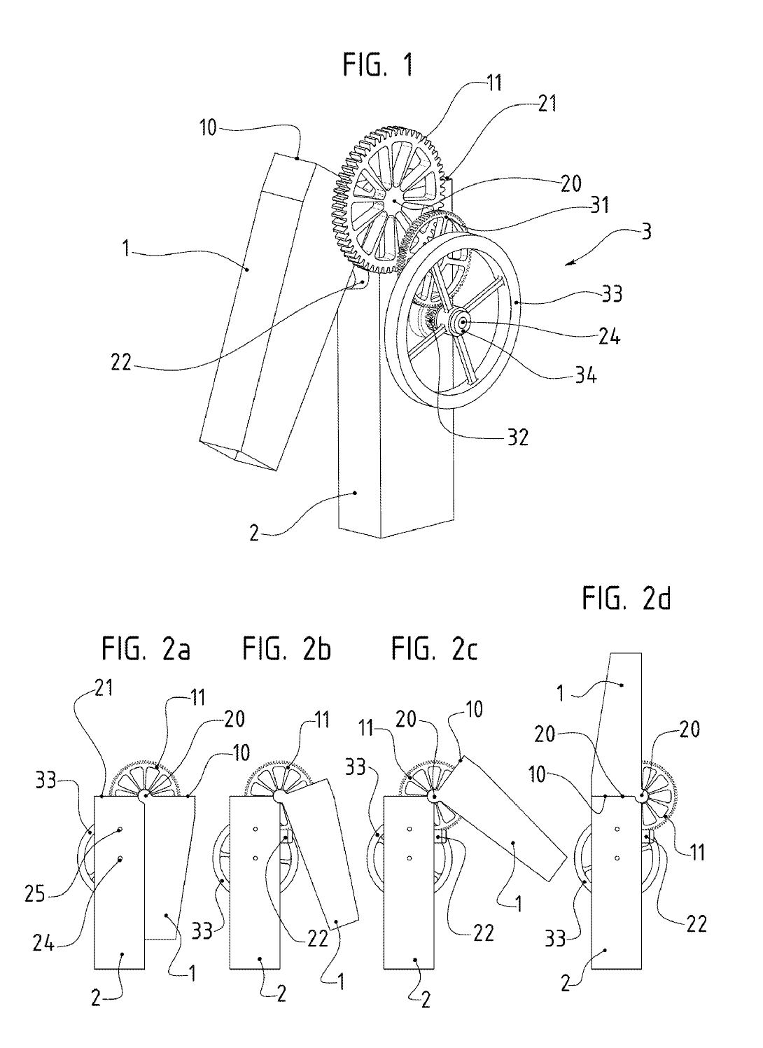

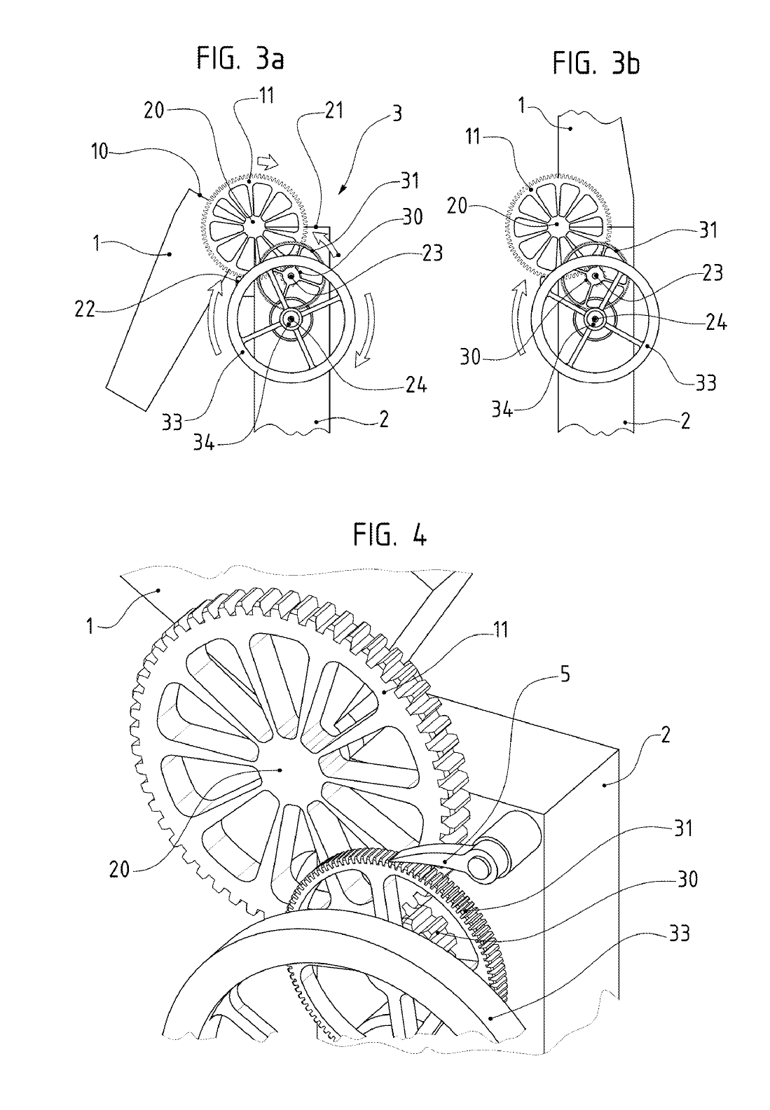

### DETAILED DESCRIPTION OF THE DRAWINGS

In the attached drawings, the shock-absorber device according to the invention is used, non-restrictively, in a particular application, namely the swiveling of a part 1 with respect to a part 2 through a pivot connection 20, and in particular the unfolding of the part 1 with respect to the part 2, in order to pass from an initial position, in which it is folded against the part 2, as shown in FIG. 2a, into an end position, in which it is in the extension of the part 2, in abutment against the extreme face 21 of the latter, with its extreme face 10, as shown in FIG. 2d.

The passing from the initial position into the end position is obtained under the effect of a thrust, which in this case consists, non-restrictively, of an impulse obtained by a spring push-rod 22, the travel length of which is voluntarily limited. When the part 1 is in storage position, the spring push-rod 22 is in withdrawn position, position in which it accumulates a certain potential energy.

It should be noted that the movement can be initiated by other means, whereby the impulse can be replaced for example by a long thrust.

In this embodiment, the shock-absorber device 3 according to the invention includes a toothed wheel 11 coaxial to the axis of the pivot connection 20, blocked in rotation on the part 1, and meshing a pinion 30 coaxially blocked in rotation on a large toothed wheel 31, which in turn meshes a pinion 32 coaxially blocked in rotation on an inertia flywheel 33. The unit comprised of the pinion 30 and a toothed wheel 31 is mounted on a shaft 23 carried by the part 2, while the unit comprised of the pinion 32 and the inertia flywheel 33 is mounted on a shaft 24 also carried by the part 2.

The unit comprised of the pinion 30 and a toothed wheel 31, intercalated between the toothed wheel 11 and the inertia flywheel 33, constitutes a step-up gear.

The operating principle of the present invention is as follows. When the spring push-rod 22 is released, it pushes back the part 1, which results into driving in swiveling the toothed wheel 11 and, through the train of gears, the inertia flywheel 33. The potential energy released by the spring push-rod 22 is distributed in kinetic energy in each of the moving parts in proportion to their inertia, which results into limiting the dynamics of the movement of the part 1.

The kinetic energy of the inertia flywheel 33 will, as the case may be, be utilizable for motorizing, if required, the part 1, for example in the case of a slowing down of the main movement due to frictions, utilizable for carrying out a locking function as will be seen hereinafter, absorbed by a slow slowing-down of the part 1.

This device is effective only when the inertia of the inertia flywheel 33 is considerable, which implies that it should be heavy. Therefore, the step-up gear, formed by the unit comprised of the pinion 30 and the toothed wheel 31, permits to increase the inertia of the inertia flywheel 33 without having to increase the mass of the latter. Through this constructive choice high inertias can be obtained, while maintaining low masses for the inertia flywheel. It should be noted that it is possible to integrate further step-up stages.

In addition, a free wheel 34 is advantageously arranged on one of the shafts, in this case on the shaft 24, intercalated between the latter and the inertia flywheel 33, in order to permit the relative movement between the shaft 24 and the inertia flywheel 33 in one single direction. The aim of this free wheel is to permit the transmission of the initial movement during the acceleration phase, to permit the free movement of the secondary part during the stopping of the part to be moved and to thus avoid an important impact, because an important portion of the kinetic energy will be biased into the free movement of the inertia flywheel 33.

The shock-absorber device 3 according to the invention permits to control the movement without any direct dissipation function, namely the use of dry or viscous friction, which is always at the origin of a potential jamming or fluctuation of operation in varying thermal ambiances. Its implementation occurs with elementary functions, all of which are already validated in the field of space navigation. It is insensitive to the thermal ambiance.

The concept permits to reduce the rapidity of the unfolding motion by artificially and temporarily increasing the inertia of the parts. By playing only with this inertia supply there is no need to increase the motorization of the movement, which does not alter the motorization margins.

The interest of the device is to permit to size correctly and with a large margin the spring function necessary for the unfolding, while limiting the dynamics of the movement and thus considerably reducing the impacts of abutment of the part 1. The speed of impact is considerably reduced by artificially increasing the inertia limited to the active phase of the movement.

It should be noted that the energy necessarily absorbed by the impact of abutment corresponds to a fraction of the initial potential energy. This energy ratio directly translates the shock-absorbing effect, since without the device the integrality of the potential energy necessary for the motorization of the movement is present in the impact of abutment.

The margin of motorization is the ratio between the energy available in the system, here the potential energy accumulated in the spring push-rod 22, and the energy exactly necessary for implementing the complete movement, generally necessary to fight against the frictions in the mechanism and necessary for the locking. In the particular domain of the space industry, motorization margins from two to three are laid on, which induces an energy to be dissipated from once to twice the energy exactly necessary for implementing the movement. In the proposed embodiment, it is possible to judiciously use the kinetic energy available in the free movement of the inertia flywheel 33 in order to increase the motorization margin.

Indeed, the relative rotation of the free wheel 34 occurs with a residual resistant friction torque and, in the case of a slowing-down of the movement due to all the external or internal resistances, the last shaft of the step-up gear decelerates, which causes a relative movement between the latter shaft of the step-up gear and the inertia flywheel 33, which tends to continue its free movement. The resistant friction torque appears and has two effects, on the one hand it causes the progressive slowing-down of the inertia flywheel, and on the other hand it is multiplied with the multiplication ratio.

Therefore, a judicious sizing can thus permit, by optimizing this function, to transfer a large portion of the kinetic energy of the inertia flywheel 33 into motorization energy, which is applied only when it is strictly necessary, i.e. in case of deceleration of the part 1. To this end, it is judicious to predefine an adequate resistance torque of the free wheel 34.

It is possible to combine both functions of limiting the energy of the abutment impact and of increasing the motorization margin, through the judicious transfer of the energy available in the inertia flywheel 33.

Advantageously, as shown in FIG. 4, it is also possible to foresee taking kinetic energy available in the free movement of the inertia flywheel 33 to provide for the locking of the unfolded parts 1 and 2, and even a pre-stress often necessary for reasons of rigidity. The energy necessary for locking or putting under pre-stress will be taken in the same way from the kinetic energy of the inertia flywheel.

It can be seen in this figure that the shock-absorber device 3 according to the invention includes a catch 5, cooperating with the toothed wheel 31, this catch 5 permits to leave the unfolding movement free, while blocking the inverse movement.

During the abutment, the continuation of the free rotation of the inertia flywheel 33 gives rise to the torque opposing the relative movement in the free wheel, which is multiplied with the multiplication coefficient on the shaft of the pivot connection 20.

It is enough to provide for any elasticity in the system, for example flexibility of the intermediate shaft in torsion, flexibility of the point of abutment, etc . . . , for this elasticity conjugated with the irreversibility due to the catch 5 to permit the pre-stress.

It should furthermore be noted that it is possible to provide for a torque limiter, which can be automatic or controlled, and which can easily be arranged at the level of the inertia flywheel 33.

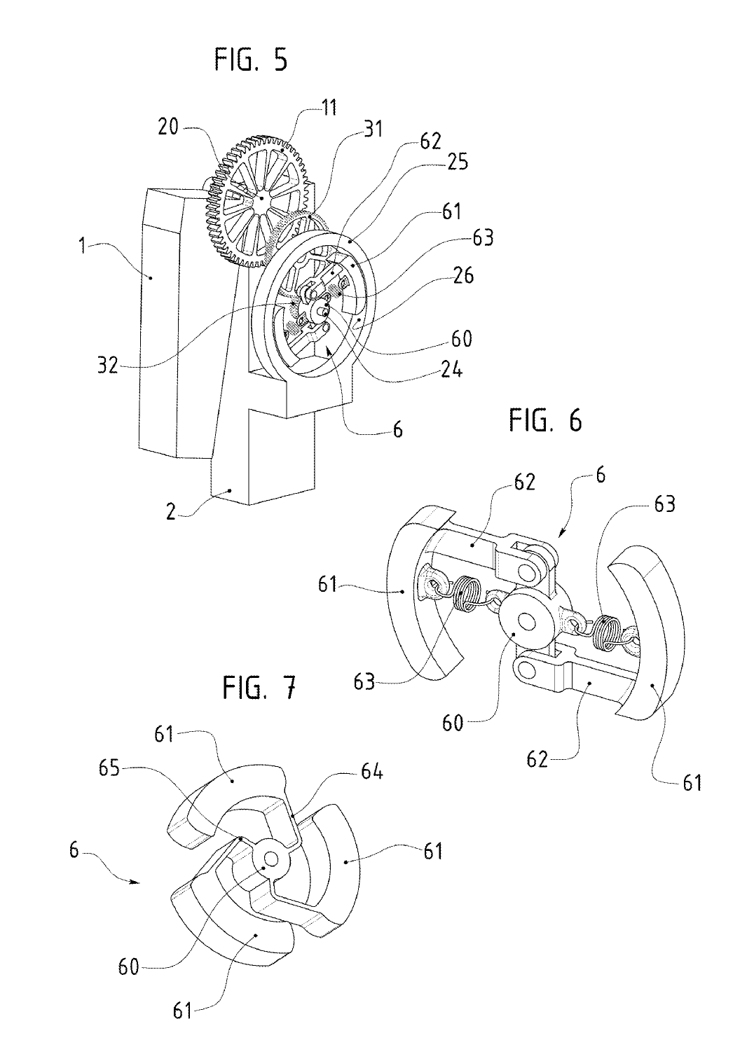

When referring now to FIG. 5, one can see a variant of the shock- absorber device according to the invention, and which differs from the above-described embodiments in that the inertia flywheel 33 is replaced by an adaptive inertia flywheel 6, also shown in FIG. 6, and another embodiment of which is shown in FIG. 7.

When referring in particular to FIG. 6, one can see that this inertia flywheel 6 comprises a means 60 aimed at being mounted onto the shaft 24 of the part 22, with or without free wheel, and blocked on the pinion 32, and which two radially movable inertia weights 61 are made integral with.

In this embodiment, each of the inertia weights consists of a mass having the shape of a ring sector, connected to the hub 60 through, on the one hand, an arm 62 pivotally hinged to the latter according to an axis parallel to that of rotation of the flywheel 6 and, on the other hand, a centripetal springy restoring means, in this case a spring 63, which namely permits to ensure a pre-stress and to maintain the inertia weights 61 in a determined initial position.

One understands that this inertia flywheel 6 has a radius varying depending on its speed of rotation, the higher the speed, the more the inertia weights 61 go away from the hub 60, which permits to modify the dynamical response of the shock-absorber device and to thus optimize the mechanism.

In FIG. 5, the adaptive inertia flywheel 6 is used as a speed limiter by being arranged concentrically in a tubular element 25 integral with the part 2, and the inner diameter of which is larger than that of the inertia flywheel 6. Starting from a certain speed of rotation of the inertia flywheel 6, the inertia weights 61 go away from the hub 60, and starting from a higher speed, they rub against the inner wall 26 of the tubular element 25, resulting into the slowing-down of the inertia flywheel, because of this slowing-down the inertia weights 61 come closer to the hubs and do no longer rub, which permits to limit the speed of rotation of the inertia flywheel 6.

The control of the speed of rotation of the inertia flywheel 6 permits, in the adaptation to the shock-absorber device according to the invention, to control the speed of unfolding of the part 1.

FIG. 7 shows another embodiment of the adaptive inertia flywheel 6, where the pivotally hinged arm and the centripetal springy restoring means, which connect each inertia weight 61 to the hub 60, are replaced by a single part 64 having deformability features. In this case, the part 64, which connects each inertia weight 61 to the hub 60, is made out of a material having springy qualities, and includes a bend 65 the angle of which is capable of varying depending on the speed of rotation of the inertia flywheel 6.

Furthermore, one can see in this FIG. 7 that the flywheel 6 includes three inertia weights 61, knowing that the number can vary.

It should be noted that the shock-absorber device according to the invention can includes an association of various above-described mechanisms.

It is thus possible to foresee several adaptive or non-adaptive inertia flywheels likely to be used in opposite directions of rotation for example by being mounted on free wheels so as to be active only in one direction of rotation, and so as to obtain different responses depending as a matter of fact on the direction of rotation.

Furthermore, the invention is described in the particular case of an application with rotary motion. It is however perfectly possible to apply it to a translation motion, by incorporating into same a mechanism for transforming any movement, such as, non-restrictively, a screw-and-nut system, a pinion-and-rack system, a pulley-and-belt or pinion-and-chain system, a connecting-rod-and-crank system.

1. Shock-absorber device comprising:
a first part and a second part, first and second parts being connected, wherein said first part is moved relative to said second part by a temporary initial thrust, provided by a motor means, relative to said second part, said first part having an initial position and an end position; and
a mechanical system connecting said parts in a relative movement, said mechanical system being comprised of a kinetic-energy accumulator being supplied by said initial thrust, and restituting at least energy exactly necessary for permitting said said first part to reach end position.

2. Shock-absorber device according to claim 1, wherein the relative movement is comprised of a swiveling motion of said first part with respect to said second part, and wherein said mechanical system comprises, a toothed wheel coaxial to an axis of said swiveling motion, and firmly integral with said first part, said toothed wheel being driven in rotation during the initial thrust and, an inertia flywheel, said inertia flywheel being comprised of the kinetic accumulator, connected in rotation to said toothed wheel.

3. Shock-absorber device according to claim 2, wherein the mechanical system further comprises a step-up gear means intercalated between the toothed wheel and the inertia flywheel.

4. Shock-absorber device according to claim 2, wherein the mechanical system further comprises a free wheel.

5. Shock-absorber device according to claim 2, wherein the mechanical system further comprises a catch cooperating with a toothed wheel, in order to ensure a locking function.

6. Shock-absorber device according to claim 5, wherein the mechanical system further comprises at least at a level of a connection between a shaft and a toothed wheel, an element having elasticity features likely to ensure, in cooperation with the catch, a locking with pre-stress.

7. Shock-absorber device according to claim 2, wherein the mechanical system further comprises a torque limiting means arranged at a level of the inertia flywheel.

8. Shock-absorber device according to claim 2, wherein the inertia flywheel has a varying diameter, said inertia flywheel comprising a hub and at least one radially movable inertia weight connected through connecting means extended and associated with centripetal springy restoring means.

9. Shock-absorber device according to claim 8, wherein the inertia flywheel with a varying diameter is arranged concentrically within a tubular element integral with the second part, carrying said inertia flywheel, and having an inner diameter corresponding to a diameter reached by said inertia flywheel at a certain speed of rotation, so that beyond said certain speed, inertia weight of said inertia flywheel rubs against an inner wall of said tubular element, in order to carry out braking.

10. Shock-absorber device according to claim 1, further comprising a plurality of inertia flywheels being used in opposite directions of rotation, by being mounted on free wheels so as to be active only in one direction of rotation, and so as to obtain different responses depending on transmitted direction of rotation.
